(19) United States
(12) Patent Application Publication
(10) Pub. No.: US 2026/0260569 A1
(43) Pub. Date: Sep. 3, 2026

(54) VERTIPORT INSTRUMENT TAKE-OFF AND LANDING PATH GUIDANCE SYSTEM

(71) Applicant: Ok Jae CHOI, Seoul (KR)

(72) Inventor: Ok Jae CHOI, Seoul (KR)

(21) Appl. No.: 18/858,361

(22) PCT Filed: Jan. 16, 2023
(86) PCT No.: PCT/KR2023/000755

§ 371 Date: Nov. 26, 2024

(30) Foreign Application Priority Data
Apr. 21, 2022 (KR) 10-2022-0049254

(51) Int. Cl. G08G 5/52; B64U 10/20; G08G 5/54

(52) U.S. Cl. CPC G08G 5/52; G08G 5/54; B64U 10/20; B64U 2201/10

(57) ABSTRACT

The present invention transmits signals from two signal sources to form a planar surface and a curved surface and guides an aircraft by using a curve generated by intersection of the two surfaces as a take-off and landing path of a vertiport, so as to guide the aircraft to a landing direction and a flight altitude during the day and night and even in weather conditions, such as snow, rain, fog, etc., where visibility is not secured, and during GPS signal reception failure and thereby provide a take-off and landing path that indicates the approach/departure directions and the approach/departure altitude with respect to a landing point to enable safe take-off and landing.

### TECHNICAL FIELD

The present invention is a technology for guiding a vertical take-off and landing (VTOL) aircraft to a touchdown and lift-off area (TLOF), and more particularly, to a technology for take-off and landing instrument guidance that indicates the TLOF and an approach/departure path of a vertiport with a wireless signal.

### BACKGROUND ART

It is widely known that when signals are transmitted from two points simultaneously, the two signals simultaneously arrive at points that are the same distance from a transmission point, and arrive with a time difference at points when transmitted from a distance with a transmission time difference. Korean Patent Laid-Open Publication No. 1020190050309 discloses a method for transmitting a guidance line signal that transmits two guidance signals with time delays from a signal source to guide a line with a straight line or a curved line in which the two signals are received simultaneously. Korean Patent Laid-Open Publication No. 1020180137376 discloses a drone landing guidance system that transmits guidance signals simultaneously to generate directional reference lines, makes two directional reference lines orthogonal to each other at a landing point, and guides a drone to a location where the two guidance signals are received simultaneously.

### RELATED ART DOCUMENT

### Patent Document

(Patent Document 1) Korean Patent Laid-Open Publication No. 1020180137376

(Patent Document 2) Korean Patent Laid-Open Publication No. 1020190050309

(Patent Document 3) Korean Patent Laid-Open Publication No. 1020190048665

### DISCLOSURE

### Technical Problem

As vertiports are built in urban areas, the vertical take-off and landing aircraft that approach/depart from and take off and land on the vertiports should fly at designated approach/departure directions and flight altitude due to surrounding obstacles, noise pollution, airspace separation, etc. Korean Patent Laid-Open Publication No. 1020180137376 describes a technology that transmits two guidance signals simultaneously to generate directional reference lines and makes the two directional reference lines orthogonal to each other at a landing point to guide an accurate landing point. However, since the approach/departure directions and flight altitude for the landing point may not be specified, the aircraft are exposed to the risk of collisions in a vertical direction with surrounding aircraft.

To solve the above problems, the present invention provides a virtual planar surface or curved surface obtained by simultaneous transmission or delayed transmission of signals to inform approach/departure directions and flight altitude of a touchdown and lift-off area (TLOF) to vertical takeoff and landing aircraft taking off and landing on a vertiport, thereby eliminating the risk of collisions in a vertical direction and provide landing field-related information such as landing field grade and allowable load and takeoff and landing-related information such as public distance, wind direction, and wind speed, thereby enabling safe take-off and landing.

### Technical Solution

To resolve the technical problem as described above, two signals delayed in time from a signal source are transmitted in a direction that is a vertically upward direction or obliquely an inclined vertically upward direction, forming a planar surface or a curved surface by points where the two signals arrive simultaneously.

A curved line formed by making the two planar surfaces or curved surfaces intersect each other at a touchdown and lift-off area (TLOF) guides a TLOF, approach/departure directions, and flight altitude for a vertiport and provides a transmission signal including landing field-related information and takeoff and landing-related information.

### Advantageous Effects

It is possible to provide the information on the path informing the landing field approach/departure directions and flight altitude for the vertiport, the information on the landing field, and the information on the takeoff and landing even in the weather conditions such as fog, snow, and rain where the pilot's visibility is not secured and in the situations where the GPS signal is unstable, and it is possible for a plurality of vertical take-off and landing aircraft to simultaneously take off and land by designating the approach/departure path (flight path) for each landing field at the vertiport with the plurality of landing fields.

### DESCRIPTION OF DRAWINGS

The drawings attached to this specification illustrate preferred embodiments of the present invention, and like reference numerals are used for like components throughout the attached drawings. In order to ensure a clear description, the drawings have been exaggerated in terms of expression or omitted when it is difficult to express the explanation in the drawings. Since the drawings serve to further provide understanding of the technical idea together with the detailed description of the present invention, they should not be interpreted only as limited to matters described in the drawings.

FIG. 1 is an explanatory diagram of a vertical take-off and landing path of Korean Patent Laid-Open Publication No. 1020180137376.

FIG. 2 is an explanatory diagram of a curved take-off and landing path of an embodiment of the present invention.

FIG. 3 is an explanatory diagram illustrating a straight and curved path of three signals of an embodiment of the present invention.

FIG. 4 is a configuration diagram of a signal source and a receiver according to an embodiment of the present invention.

### BEST MODE

The terms or words used in this specification and claims should not be construed as being limited to their conventional or dictionary meanings, and features of different embodiments described may be combined with each other unless specifically stated otherwise. The terms used in the description have been appropriately defined to describe the present invention, and the terms should be interpreted by meanings and concepts consistent with the technical idea. A detailed description of well-known functions and configurations that may unnecessarily make the gist of the present invention unclear will be omitted.

When signals are transmitted from two points simultaneously, the two signals travel for the same time and arrive at centers of the two points simultaneously, and simultaneous arrival points form a straight line and a planar surface. When the signals are transmitted with a time difference, the two signals travel for the same time and arrive at points with a distance difference that is as great as a time difference simultaneously, and the simultaneous arrival points form a curved line and a curved surface.

The present invention is a wireless radio navigation technology that may replace a takeoff and landing guidance technology using GPS navigation as a path guidance technology that guides a vertical take-off and landing (VTOL) aircraft to a touchdown and lift-off area (TLOF) by indicating a flight path that guides approach/departure directions and altitude of the TLOF using a virtual curved line generated in the air with a wireless signal during the day and night and even in weather conditions such as snow, rain, fog where visibility is not secured and a situation of GPS signal reception failure.

Hereinafter, various embodiments of the present invention will be described in detail with reference to the accompanying drawings and contents described in the drawings. However, the present invention is not limited to these exemplary embodiments.

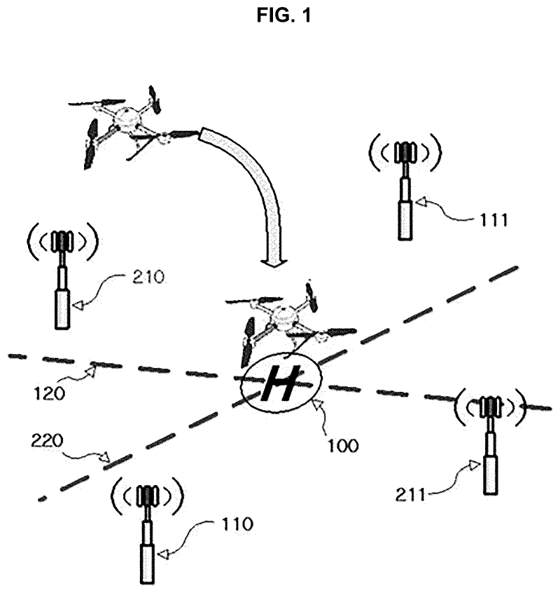

FIG. 1 is an explanatory diagram of a landing guidance system of Korean Patent Laid-Open Publication No. 1020180137376, which is a related art. Referring to Korean Patent Laid-Open Publication No. 1020180137376 in detail, two signals that are transmitted simultaneously indicate straight directional reference lines 120 and 220, and the two directional reference lines 120 and 220 intersect at a landing point to guide a drone to the landing point. The landing point guided by intersecting the two directional reference lines 120 and 220 may not specify a direction and flight altitude of an approach/departure path of the drone, so an altimeter or GPS device that informs the altitude is required. The two planar surfaces including the two directional reference lines 120 and 220 are planar surfaces in a direction perpendicular to the ground. When the two directional reference lines intersect, a virtual straight line perpendicular to the ground is generated, which may also not specify the flight altitude, so the aircraft may not avoid the risk of a collision above and below with surrounding drones flying in the same direction. To solve the above problem, the system requires a separate configuration to guide the flight altitude.

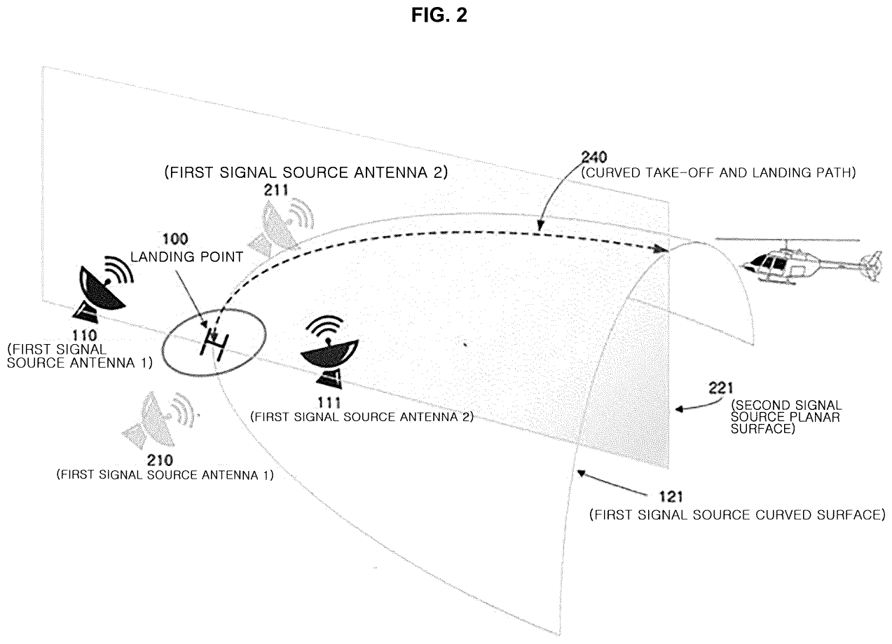

FIG. 2 is an explanatory diagram of a curved take-off and landing path according to an embodiment of the present invention.

Referring to FIG. 2, two antennas 110 and 111 of the first signal source transmit signals in a direction perpendicular to the ground with a time difference to form a curved surface 121 perpendicular to the ground, in which points where the two signals arrive simultaneously indicate a flight altitude, two antennas 210 and 211 of the second signal source transmit signals at the same time in a direction perpendicular to the ground to form a planar surface 221 perpendicular to the ground, in which points where the two signals arrive simultaneously indicate a flight direction. The first signal source and the second signal source are installed so that the curved surface 121 and the planar surface 221 intersect at a landing point 100, thereby generating a virtual curved line. The generated curved line becomes a take-off and landing path 240 that informs the approach/departure directions and flight altitude for the landing point 100. The curved line is the take-off and landing path 240 that provides an accurate take-off and landing path without an altimeter or a global positioning system (GPS) even in bad weather and limited visibility situations.

By transmitting the signals from the two signal sources with the time difference to form the two curved surfaces, and by appropriately adjusting the transmission time difference to change the curvatures of the two curved surfaces, it is possible to change the approach/departure directions and flight altitude of the take-off and landing path without changing the positions of the antennas of the two signal sources.

By adding a signal source forming a surface opposite to the curve surface 121 of the first signal source to the take-off and landing path 240 generated by the intersection of the curve surfaces 121 and the planar surface 221 of the first and second signal sources, it is also possible to provide a take-off and landing path in the opposite direction of the take-off and landing path 240 by the curved line generated by intersecting the planar surface 221 of the second signal source and the landing point 100.

By generating a plurality of curved take-off and landing paths with a plurality of planar surfaces and curve surfaces formed by a plurality of signal sources, it is also possible to provide a plurality of take-off and landing paths that inform different approach/departure directions and flight altitudes for a vertiport having a plurality of landing fields.

Transmitting two signals from a signal source simultaneously or with a time difference is the same as performing delayed transmission with a time difference or delayed transmission with the same time difference and transmitting two time-synchronized signals with each having a time delay.

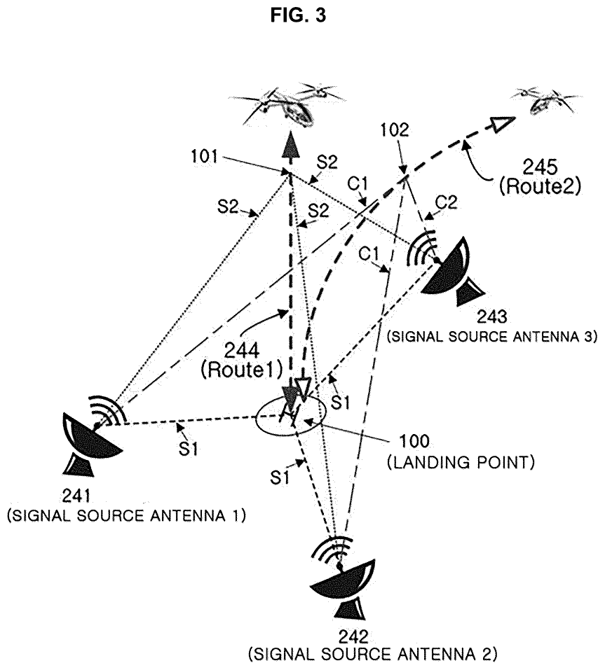

FIG. 3 is an explanatory diagram illustrating a straight and curved take-off and landing path using three signals according to an embodiment of the present invention.

Referring to FIG. 3, when a S1 signal and a S2 signal are transmitted simultaneously from an antenna 1 241, an antenna 2 242, and an antenna 3 243 of a signal source positioned at the same distance from a landing point in a landing field, the S1 signals travel at the same time from the three antennas 241, 242, and 243 and arrive at the landing point 100 at the same distance at the same time. The S2 signals travel for a longer time than the S1 signal and simultaneously arrive at the point 101 from the same distance from the three antennas 241, 242, and 243. The signals transmitted simultaneously from the signal source will simultaneously arrive on a straight line connecting the landing point 100 and point 101, and the arrival points will form an upward straight path 244.

When the antenna 1 241 and the antenna 2 242 of the signal source transmits C1 signals simultaneously and the antenna 3 243 transmits a C2 signal with a time difference with the C1 signal, the C1 signals simultaneously transmitted will simultaneously arrive at a center point of the straight line connecting the antenna 1 241 and the antenna 2 242, the landing point 100, and the points 101 and 102, and all points that are reached simultaneously will form a planar surface including the points 100, 101, and 102. The C2 signal will travel a shorter distance than the C1 signals, which is as great as the time difference, and the two C1 signals and C2 signal will simultaneously arrive at the point 102 on the planar surface formed by the two C1 signals. All the points where the two C1 signals simultaneously transmitted and the C2 signal transmitted with a time difference arrive simultaneously will be a curved line 245, which is the same as the curved take-off and landing path 240.

When one antenna is added to the signal source and installed in the opposite direction of the antenna 3 243, and the signal is transmitted at a delay with the time difference with respect to the C1 signal, the curve in the opposite direction to curve line 245 may be obtained, so that a curved take-off and landing path in two directions may be provided using four antenna signals.

By the transmission delay time of the signal source, all the three signals can be transmitted at a delay with a time difference and transmitted at a delay with the same time difference.

When the signal source appropriately adjusts the time difference of the three signals and transmits the three signals, the direction of the curve take-off and landing path and the flight altitude can be changed without changing the position of the antenna.

The vertical take-off and landing aircraft receives signals informing the curved take-off and landing paths 240 and 245 and controlling the aircraft so that all the signals are received simultaneously, so the aircraft can approach/depart and take off and land along the provided curved take-off and landing path 240 and 245, and autonomous take-off and landing of unmanned aerial vehicles can be guided.

The two delayed signals may have delay time errors due to various factors such as length errors of the two transmission cables or processing time deviations of internal components. Positional errors due to the time errors of the two signals have a characteristic of being increased when the distance from the two antennas increases.

The delay time error of the generated two signals can be corrected by adding a hardware correction circuit, or the delay time error can be corrected by software calculation.

The delay time error can be detected by detecting the time difference between the signals transmitted to the two antennas inside a signal source transmitter, can be detected by enabling the antennas to receive the two signals transmitted from the signal source to detect the time difference, or can be detected by allowing error detectors installed at the points where the two transmission signals arrive simultaneously to determine that there is an error when the two signals are received with a time difference.

The ID may be included in the signal to distinguish the signals transmitted from the signal source, and it is also possible to transmit the wind direction and wind speed information of the landing field, the landing field information, and the takeoff and landing-related information to one of the signals transmitted from the signal source.

By adding an altitude signal source that forms the planar surface parallel to or inclined with respect to the ground, it is possible to indicate a specific altitude of the landing path, or by intersecting the take-off and landing path, it is possible to indicate a boundary altitude of deceleration and acceleration areas, a landing determination altitude, etc.

By installing a marker signal source that forms a planar surface perpendicular to the ground at a specific distance from the landing field, it is also possible to indicate the distance to the landing point.

When the position calculation information is transmitted by being added to one of the signals of the signal source that generates the take-off and landing path installed at the landing field and the position calculation information is transmitted by being added to one of the two signals transmitted to form the planar surface in the marker signal source in response to the reception of the signal to which the position calculation information is added from the marker signal source, the closer the reception locations of the two position calculation information signals is to the landing field, the later the signal of the marker signal source is received, resulting in a large reception time difference, and since the closer the marker signal source, the smaller the reception time difference becomes, the reception time difference between the two signals to which the position calculation information is added is obtained from the aircraft, so it is also possible to calculate the distance to the landing field based on the distance between the landing field signal source and the marker signal source and the reception time difference.

The position calculation information can be any of time, distance, etc., and a combination of these is also made possible. The time may be the time at the landing field, the transmission time of each of the two signal sources, or the transmission time of the landing field signal source.

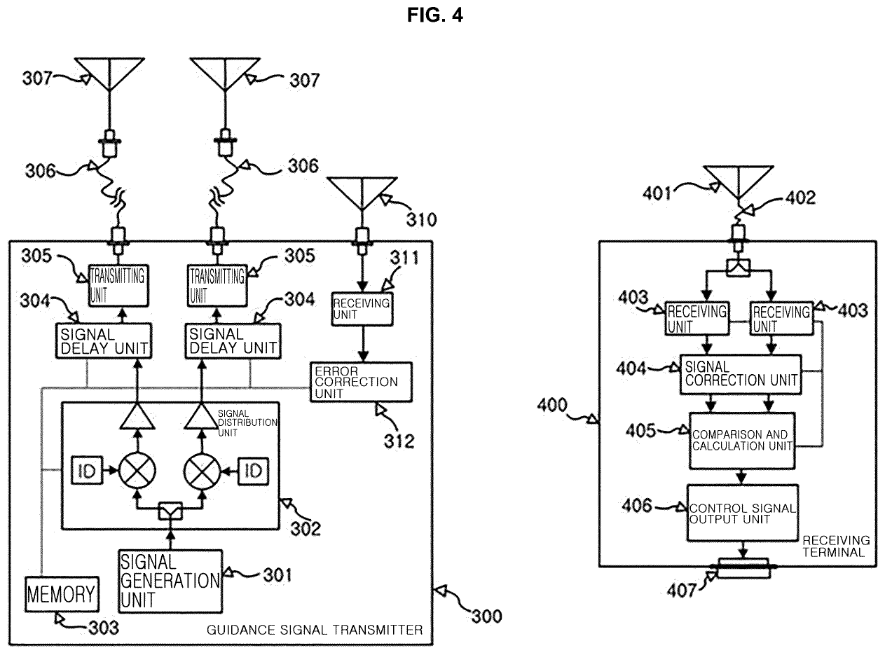

FIG. 4 is a configuration diagram of a signal source and a receiver according to an embodiment of the present invention.

In describing an embodiment of a configuration of the signal source and a configuration of the receiver with reference to FIG. 4, the signal source includes a signal transmitter 300, two transmission lines 306, and two antennas 307, and the receiver includes an antenna 401, a transmission line 402, and a receiving terminal 400.

The signal transmitter 300 of the signal source includes a signal generation unit 301 that generates a reference signal, a signal distribution unit 302 that adds an ID to two divided reference signals and modulates the reference signals, a memory 303 that sets and stores the ID and delay time, two signal delay units 304 that correct the time delay and errors of the two signals with the set time of the memory 303, and two transmitting units 305 that amplify and output the signals. The time delay and correction may be made possible even with a single signal delay unit 304. It may also be possible to correct errors by further adding to the signal transmitter 300 of the signal source an antenna 310 that receives the transmission signal of the two antennas 307, a receiving unit 311 that divides the signal into two signals and demodulates the signals, and an error detection unit 312 that detects the time error of the two demodulated signals, generates the corrected information, and transmits the generated corrected information to the signal delay unit 304.

It is also possible to implement signal distribution and transmission time delay, ID addition, and time delay error correction functions in software by adding a processor.

The two transmission lines 306 are lines of the same length having the same characteristics of signal delay and transmission speed. The time difference delay of the signal may also be made possible by utilizing the difference in the length of the two transmission lines 306 or the difference in the signal delay characteristic of the two transmission lines 306.

The receiving terminal 400 includes a distributor that divides the signal into two, two receiving units 403 that demodulate the ID added to the receiving signal, a signal correction unit 404 that corrects a processing time error of the receiver itself, a comparison and calculation unit 405 that manages the receiving unit 403 and the signal correction unit 404 and compares and calculates the reception time difference or signal phase of the two signals, and control signal output units 406 and 407 that output a comparison and calculation result to a flight control device. When the comparison and calculation unit itself corrects the processing time error through the software, a configuration in which the signal correction unit 404 is removed may also be made possible.

The processing time error of the receiving terminal 400 itself is corrected by demodulating one of the two ID signals received by the antenna 401 in the two receiving units 403, comparing the demodulated identical ID signals of the two receiving units 403 in the comparison and calculation unit 405, and transmitting the difference in the reception time as the correction value to the signal correction unit 404.

The signal source may be configured to include the signal transmitter 300, three to four transmission lines 306, and three to four antennas 307, the signal transmitter 300 may be configured to include the signal generation unit 301, the memory 303, the signal distribution unit 302 that distributes signals into three to four signals and adds IDs, three to four signal delay units 304, and a transmitting unit 305, and the receiving terminal 400 may be configured to include the distribution unit that distributes signals into three to four signals, the three to four receiving units 403, the signal correction unit 404, the comparison and calculation unit 405, and the control signal output unit 406.

The ID of the transmission signal is used to distinguish the signal transmitted from each antenna of the signal source and to distinguish each signal source. The ID is unique data, and the signal modulated by adding the ID can be modulated in various ways such as analog modulation, digital modulation, and orthogonal frequency division multiplexing (OFDM) modulation. The frequency may be different frequencies that have little influence on each other. The medium of the signal may be any of light, electromagnetic waves, sound waves, etc.

FIG. 4 merely illustrates an example of a signal source transmitting two signals and a receiver receiving the two signals, and therefore, the signal source and receiver according to the present invention should not be interpreted as being limited to those illustrated in FIG. 4.

In order for an autonomous flying aircraft to fly more than a maximum flight distance, fuel should be refilled. A takeoff and landing guidance system may be installed at a charging station to accurately guide the aircraft to land on a charging device of the charging station and be used by the aircraft to charge.

The embodiments of the present invention described above and illustrated in the drawings should not be construed as limiting the technical idea of the present invention. The scope of protection of the present invention is limited only by the matters stated in the claims, and any modifications and changes to the technical idea of the present invention that are obvious to a person skilled in the art will fall within the scope of protection of the present invention.

1. A method of providing a take-off and landing path for a vertical take-off and landing aircraft, the method comprising:
time-delaying two time-synchronized signals of a first signal source and time-delaying two time-synchronized signals of a second signal source at a landing field;
transmitting the two signals of the first and second signal sources in a direction perpendicular to the ground or obliquely in the direction perpendicular to the ground to form a planar surface or a curved surface by points where the two signals arrive simultaneously; and
intersecting the planar surfaces or the curved surfaces of the first and second signal sources at a touchdown and lift-off area (TLOF) to obtain a curved take-off and landing path that guides a flight direction and a flight altitude from the TLOF in the air.

2. A method of providing a take-off and landing path for a vertical take-off and landing aircraft, the method comprising:
time-delaying three signals synchronized in a signal source of the landing field;
transmitting the three signals of the signal source in a direction perpendicular to the ground or obliquely in the direction perpendicular to the ground to form a straight line or a curved line by points where the three signals arrive simultaneously; and
providing a take-off and landing path that guides a flight direction and a flight altitude so that the straight line or curved line faces a specific direction in the air from the landing point on the ground.

3. The method of claim 1, further comprising guiding a specific altitude by the planar surface formed by points where the two signals arrive simultaneously by further adding a signal source that simultaneously transmits the two signals in a direction parallel to the ground or a direction obliquely inclined to the ground.

4. The method of claim 1, further comprising correcting a time error of the two signals transmitted by the first signal source and the second signal source.

5. The method of claim 1, further comprising adding an identification (ID) for distinguishing the signals of the signal source.

6. The method of claim 1, further comprising adding wind direction and wind speed information and landing field information to any one of the signals.

7. A vertical take-off and landing aircraft landing guidance system, comprising:
a first signal source and a second signal source, the first signal source transmitting time-synchronized two signals at a landing field, respectively, with a time delay, in a direction perpendicular to ground or obliquely in a direction perpendicular to the ground and forming a planar surface or a curved surface at simultaneous arrival points of the two signals, and the second signal source transmitting time-synchronized two signals, respectively, with a time delay in a direction perpendicular to the ground or obliquely in a direction perpendicular to the ground and forming a planar surface or a curved surface at simultaneous arrival points of the two signals, so that the planar surface or the curved surface of the first signal source and the planar surface or the curved surface of the second signal source intersect each other at a landing point to guide a curved take-off and landing path of a vertical take-off and landing aircraft; and
a receiving terminal that outputs a flight path change control signal of the vertical take-off and landing aircraft so that the two signals of the first signal source and the two signals of the second signal source are received sequentially when the two signals of the first signal source and the two signals of the second signal source are received sequentially.

8. A vertical take-off and landing aircraft landing guidance system, comprising:
a signal source that transmits three time-synchronized signals, each with time delay by three antennas of the signal source at a landing field and provides a take-off and landing path as a straight line or a curved line formed by all points including touchdown and lift-off areas (TLOFs) where the three signals arrive simultaneously; and
a receiving terminal that is mounted in the vertical take-off and landing aircraft and outputs a control signal for changing a course so that the three signals of the signal source are received simultaneously when the three signals of the signal source are received sequentially.

9. The method of claim 7, further comprising a signal source that simultaneously transmits two signals vertically upward with respect to the ground from a specific distance of the landing field and informs of the specific distance from the landing field to the planar surface formed by points where the two signals arrive simultaneously,
wherein the receiving terminal further includes a function for recognizing the specific distance.

10. The method of claim 7, further comprising a signal source that simultaneously transmits two signals in the direction parallel to the ground or in the direction obliquely inclined to the ground to form the planar surface so as to inform a specific altitude,
wherein the receiving terminal further includes a function for recognizing the specific altitude.

11. The method of claim 7, wherein the receiving terminal itself further includes a function for correcting a signal processing time error of the receiving terminal.

12. A position recognition system of a take-off and landing path of a take-off and landing aircraft, the position recognition system comprising:
a signal source that transmits a transmission signal including position calculation information from one of signal sources providing a take-off and landing path of a landing field;
a signal source that is located on the take-off and landing path and located at a specific distance from the landing field, the signal source being located at the specific distance and transmitting a position calculation information signal in response to receiving a signal including position calculation information transmitted by the signal source; and
a receiving terminal that receives the position calculation information signals from the two signal sources and calculates a position on the take-off and landing path using a specific distance and a reception time difference between the two signals.

13. The method of claim 2, further comprising guiding a specific altitude by the planar surface formed by points where the two signals arrive simultaneously by further adding a signal source that simultaneously transmits the two signals in a direction parallel to the ground or a direction obliquely inclined to the ground.

14. The method of claim 2, further comprising adding an identification (ID) for distinguishing the signals of the signal source.

15. The method of claim 3, further comprising adding an identification (ID) for distinguishing the signals of the signal source.

16. The method of claim 2, further comprising adding wind direction and wind speed information and landing field information to any one of the signals.

17. The method of claim 3, further comprising adding wind direction and wind speed information and landing field information to any one of the signals.

18. The method of claim 8, further comprising a signal source that simultaneously transmits two signals vertically upward with respect to the ground from a specific distance of the landing field and informs of the specific distance from the landing field to the planar surface formed by points where the two signals arrive simultaneously,
wherein the receiving terminal further includes a function for recognizing the specific distance.

19. The method of claim 8, further comprising a signal source that simultaneously transmits two signals in the direction parallel to the ground or in the direction obliquely inclined to the ground to form the planar surface so as to inform a specific altitude,
wherein the receiving terminal further includes a function for recognizing the specific altitude.

20. The method of claim 8, wherein the receiving terminal itself further includes a function for correcting a signal processing time error of the receiving terminal.
